(19) United States
(12) Patent Application Publication
(10) Pub. No.: US 2006/0092891 A1
(43) Pub. Date: May 4, 2006

(54) Controlled area signalling

(75) Inventors: Howard E. Goldberg, Wynnewood, PA (US); Alain Charles Louis Briancon, Poolesville, MD (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/184,683

(22) Filed: Jul. 19, 2005

Related U.S. Application Data
(60) Provisional application No. 60/623,091, filed on Oct. 28, 2004.

(51) Int. Cl. H04Q 7/24

(52) U.S. Cl. 370/338; 370/465

(57) ABSTRACT

In one embodiment, a signal associated with a service not permitted in the controlled area of a wireless transmit/receive unit is received. An identifier is sent indicating that the WTRU is in a controlled area. In a second embodiment, the transfer of data associated with a controlled area is controlled. In the controlled area, the transfer of certain data is restricted. The data associated with the controlled area is collected. The collected data is identified as being associated with the controlled area. The transfer of the identified collected data is restricted, where data that is not identified as being associated with the controlled area is not restricted.

### CROSS REFERENCE TO RELATED APPLICATION

This application claims the benefit of U.S. Provisional Application No. 60/623,091 filed Oct. 28, 2004, which is incorporated by reference as if fully set forth.

### FIELD OF INVENTION

This invention relates to wireless communications. In particular, this invention relates to controlled areas for such communications.

### BACKGROUND

Miniaturization is allowing devices to perform functions, not traditionally performed by such devices. Some examples include cameras, microphones, sound detectors and speaker phones in cellular phones, personal digital assistants (PDAs), watches, among other devices. Privacy control schemes are being developed and deployed to restrict the usage of these devices or device features in certain places. Such privacy control schemes may use beacon systems, detectors and watermarks to enforce rules to restrict these features, such as rules for the use/type of information that can be recorded.

To illustrate, a user may be sitting in a movie theater, where voice calls (excluding emergency calls) and photography are prohibited. However, short message service (SMS) and may be permitted. By contrast, during a test of a school or University class, SMS may be deactivated.

In these situations, someone attempting to communicate with a device in a privacy controlled area may not be successful. To illustrate, a caller makes a voice call to an individual in an area, where voice calls are prohibited. Since the call was unsuccessful, the caller may believe the individual's wireless device is turned-off or outside the range of its wireless network. The caller will not know that such an individual is in actually in the network and could be communicated through SMS.

Accordingly, it is desirable to have better control area systems.

### SUMMARY

In one embodiment, a signal associated with a service not permitted in the controlled area of a wireless transmit/receive unit is received. An identifier is sent indicating that the WTRU is in a controlled area. In a second embodiment, the transfer of data associated with a controlled area is controlled. In the controlled area, the transfer of certain data is restricted. The data associated with the controlled area is collected. The collected data is identified as being associated with the controlled area. The transfer of the identified collected data is restricted, where data that is not identified as being associated with the controlled area is not restricted.

### BRIEF DESCRIPTION OF THE DRAWING(S)

FIG. 1 is an illustration of network based privacy zone identifier signaling.

FIG. 2 is an illustration of network based storage of session data for later transmittal to a wireless transmit/receive unit.

FIG. 3 is an illustration of rerouting session data when a wireless transmit/receive unit is in a privacy zone.

FIG. 4 is an illustration of wireless transmit/receive unit base privacy zone identifier signaling.

FIG. 5 is an illustration of network based storage of session data as initiated by a wireless transmit/receive unit.

FIG. 6 is an illustration of rerouting session data as initiated/rerouted by a wireless transmit/receive unit.

### DETAILED DESCRIPTION OF THE PREFERRED EMBODIMENT(S)

Although the features and elements of the present invention are described in the preferred embodiments in particular combinations, each feature or element can be used alone (without the other features and elements of the preferred embodiments) or in various combinations with or without other features and elements of the present invention.

Hereafter, a wireless transmit/receive unit (WTRU) includes but is not limited to a user equipment, mobile station, fixed or mobile subscriber unit, pager, or any other type of device capable of operating in a wireless environment.

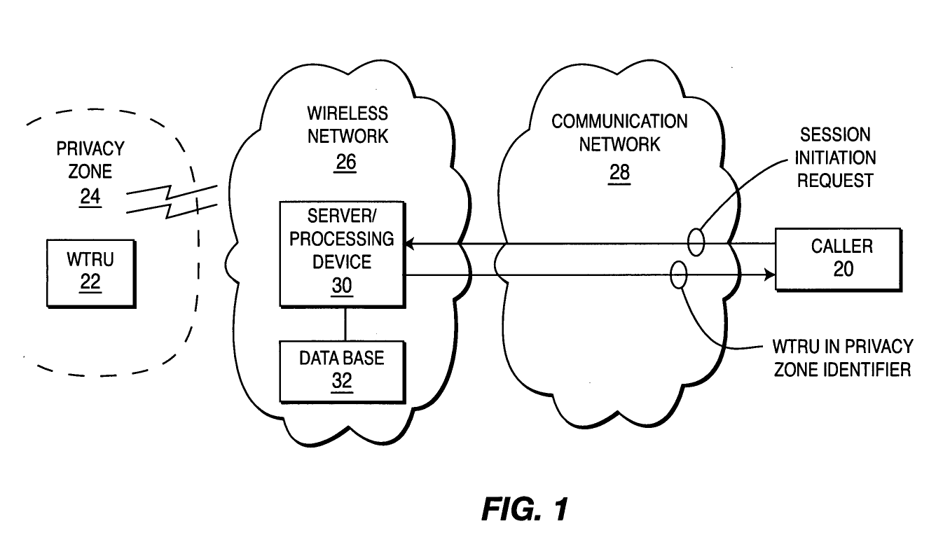

FIG. 1 is an illustration of an embodiment for a caller 20 attempting to communicate with a WTRU 22 in a controlled area (privacy zone) 24, where certain or all WTRU functions are prohibited/restricted. A caller 20 wishes to communicate with the WTRU 22. The communication may be voice, SMS, multimedia service (MMS) or other data service. The caller 20 attempts to initiate the service or an additional service. Although the following refers to the caller 20 as initiating a call, the caller 20 may not initiate the service in some embodiments. The caller 20 may be another user using a communication device, server, processor or monitoring device.

The associated service initiation request is routed through one or multiple communication network(s) 28, such as telephony, cellular, WiFi, Internet, Broadband, among others. The service initiation request is sent to a wireless network 26 (including the core network and radio access network) of the WTRU 20 and a network controller 30, such as a network server or network processing device.

The network controller 30 determines that the WTRU 22 is in a privacy zone 24 and sends a message to the caller that the WTRU 22 is a privacy zone 24. Additionally, the message may indicate which services are permitted or prohibited in the privacy zone 24. The privacy zone indicator is routed though the communication network(s) 28 to the caller 20.

As illustrated in FIG. 1, the network controller 30 has a server or processing device and an associated database 32. An identifier of WTRUs known to be in privacy zones is preferably stored in the database 32. Additionally, the database 32 may indicate which services are permitted or prohibited by the WTRU 22 or within the privacy zone 24. When a service initiation request for a particular WTRU 22 is received by the network controller 20, the network controller 20 uses the database 32 to determine whether the WTRU 22 is in a privacy zone 24 and whether that service being requested is permitted in the privacy zone. If the WTRU 22 is not in a privacy zone 24 or that service is permitted in the privacy zone 24, the service request is sent to the WTRU 22. If the WTRU 22 is in a privacy zone 24 where the requested service is not permitted, the server/processing device 30 sends an identifier indicating that the recipient WTRU 22 is in a privacy zone 24 to the caller. Additionally, the server/processor 30 may send a message indicated which services are permitted or prohibited in that privacy zone 24.

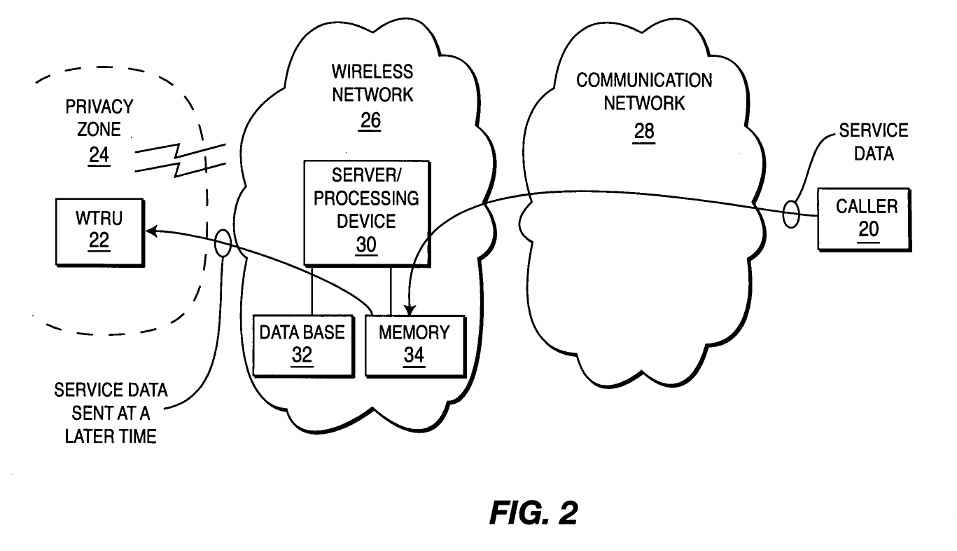

In an alternate embodiment as shown in FIG. 2, the network controller 30 or other network device may act as the recipient of the message. The network (wireless network 26, as shown, or communication network 28) stores the data (voice, SMS, MMS, internet protocol (IP) or other), such as by using a memory 34, until the WTRU 22 is permitted to receive such services. Once the WTRU 22 can receive the services or the user requests transmission of the service data, the data is sent to the WTRU 22.

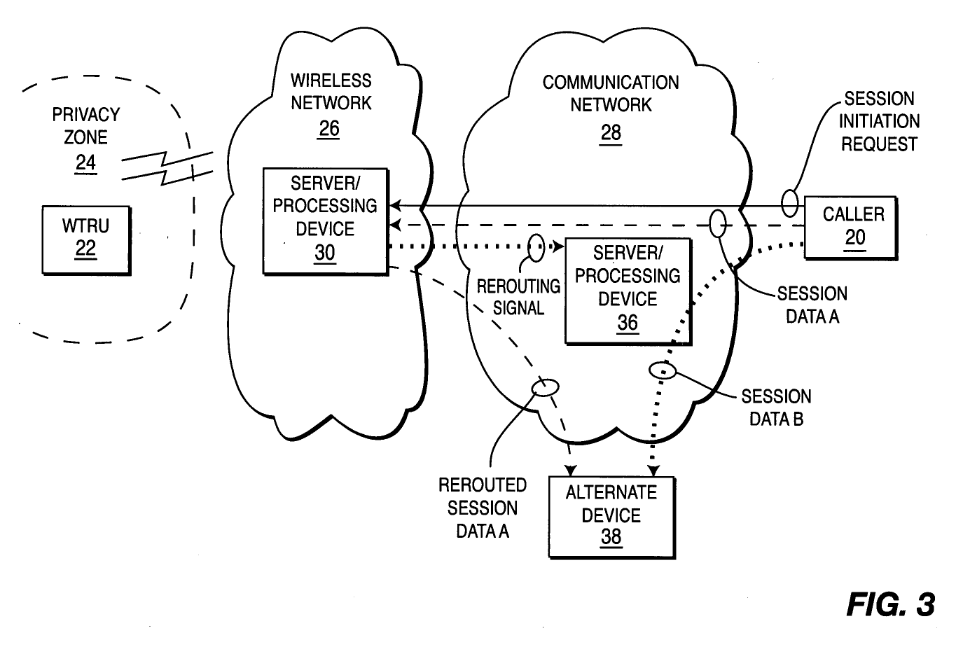

In another alternate embodiment as shown in FIG. 3, when the WTRU 22 is in a privacy zone 24 prohibiting the session, the network controller 30 may reroute the session to a predetermined alternate device 38. To illustrate, a user of a WTRU 22 may be in a meeting area, where voice calls are prohibited. The network controller 30 reroutes the voice call to an alternate telephone, such as the individual's office telephone, the individual's administrative assistant's telephone or to a telephone of an individual immediately outside the meeting area. The rerouting is preferably controlled by the user of the WTRU 22, although the network may control the rerouting.

To facilitate, the rerouting, the network controller 30 may reroute the session data or encapsulate the data. As shown by dashed lines, the network controller receives the session data A and reroutes that data to the alternate device 38. Alternately, as shown by dotted lines, the network controller 30 may send a signal to the communications network(s) 28 to have the call rerouted in that network 28, such as a call forwarding signal. Session data B is rerouted by the server/processing device 36 of the communication network(s) 28.

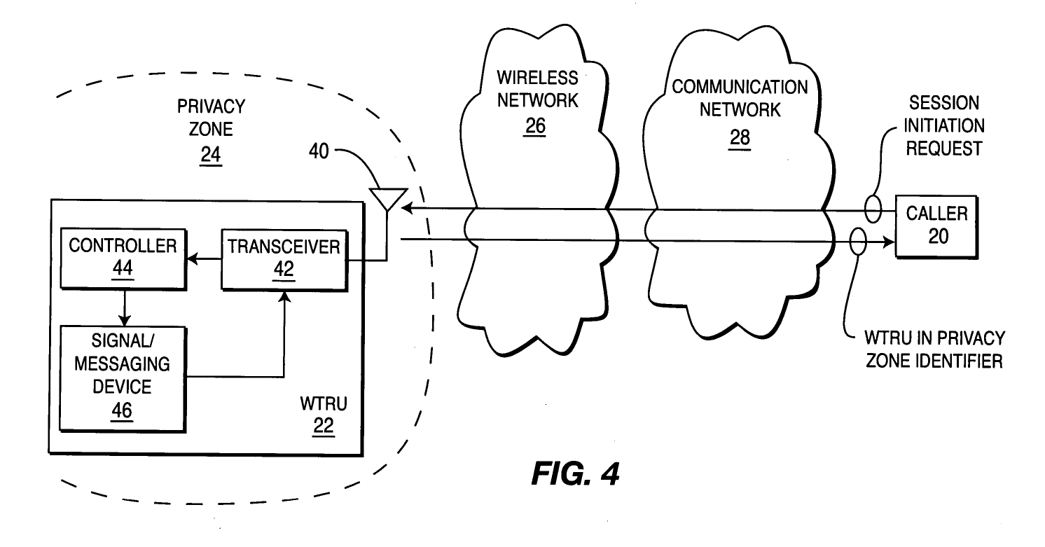

FIG. 4 is an illustration of another embodiment for a caller 20 attempting to communicate with a WTRU 22 in a privacy zone 24. A service initiation request is routed through one or multiple communication network(s) 28 and through the WTRU's wireless network 26 to the WTRU 22. The WTRU 22 receives the session initiation request and is aware that it cannot initiate the session as the WTRU 22 is in a privacy zone 24 prohibiting/restricting that session's service. The WTRU 22 sends the network 26 an indicator that it is in a privacy zone. The indicator may also indicate which services that the WTRU 22 is permitted or prohibited. The indicator is sent through the communication network(s) 28 to the caller 20.

As illustrated in FIG. 4, the WTRU has an antenna 40 or antenna array and a transceiver (Xceiver) 42 for receiving the session initiation request. In response to the request, a controller 44 determines whether the session is permitted, whether the privacy zone 24 allows such sessions. If the session is not permitted, a signal/message device 46 produces the privacy zone indicator and the message/signal is transmitted by the transceiver 42 over an antenna 40 or antenna array.

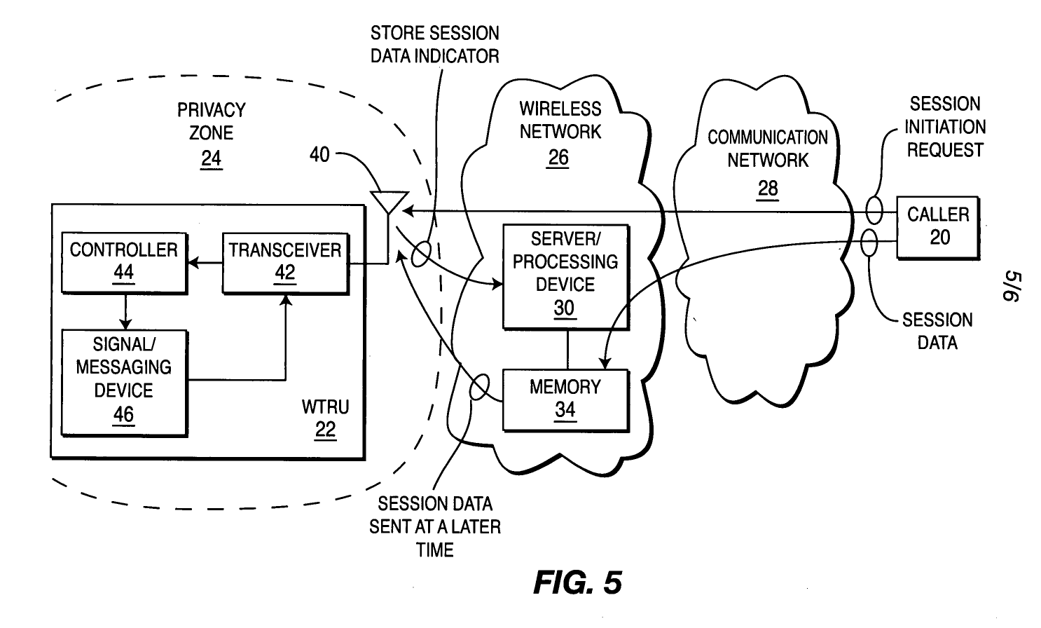

In an alternate embodiment as illustrated in FIG. 5, the WTRU 22 may send an indicator to the wireless network 26, as an alternative or in addition to the privacy zone indicator, indicating that the wireless network 26, as shown, or communication network(s) 28 should store the session data. In response to receiving the indicator, the wireless/communication network 26 stores the session data, such as by using a memory 34 associated with the network controller 30.

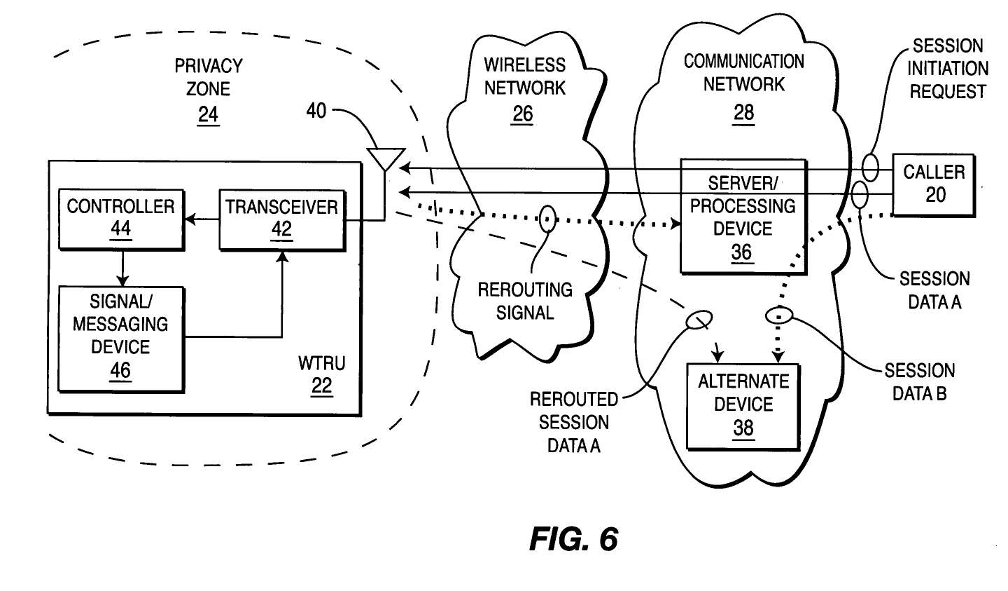

In an alternate embodiment as illustrated in FIG. 6, the WTRU 22 may have the data sent to an alternate device 38. As shown by dotted lines, the WTRU 22 may send a signal to the wireless network 26 or the communication network(s) 28, as shown, to have the session rerouted (session data A). Alternately, as shown by dashed lines, the WTRU 22 may reroute or encapsulate the session data (session data B) for transfer to the alternate device 38.

Although FIGS. 1-6 illustrate signaling when a session is initiated, the same signaling may be used when a session is already underway. To illustrate, a WTRU may already have a voice session initiated, when the WTRU moves within a privacy zone prohibiting such sessions. At that time, the privacy zone indicator is sent to the caller to indicate that the user moved into a privacy zone. This privacy zone indicator provides the caller with information that the calls was not due to poor service (such as the call being dropped). Similarly, the session data may be stored or rerouted to an alternate device.

In the embodiments of FIGS. 1-6, the components of the WTRU 22 or network controllers 30, 36 may be implemented using a single integrated circuit (IC), such as an application specific integrated circuit (ASIC), multiple ICs, a logical programmable gate array (LPGA), multiple LPGAs, discrete components or a combination of any of IC(s), LPGA(s) and discrete components.

In certain implementations, the privacy zone restrictions may be overridden by either an operator of a WTRU 22 or the caller 20. Such an override may be done by an input/code/signal/message. To illustrate, a user may be in a meeting area scheduled for a specified time period. The meeting may end early, but the privacy zone 24 may still be established. In such a situation, the user may depress a special key on the WTRU 22 to override the privacy zone restriction. Such a feature may only be permitted in certain types of privacy zones 24.

Additionally, data generated by a WTRU 22 in a privacy zone 24 may not be permitted to be transferred. To illustrate, a WTRU 22 may have a recording device or sensors capable of recording or collecting information regarding a privacy zone 24, such as pictures, sensor data, presence information, etc. The transfer of this data/information may be prohibited or only permitted to certain authorized users. The transfer of this restricted data would also commonly be prohibited when the WTRU 22 is outside of the privacy zone 24.

Such restricted data/information may be stored at the WTRU 22 or at the network 26, 28. The stored data/information has some type of an identifier of its association with the privacy zone 24. The identifier may be a watermark or metadata, such as a time and place stamp. When a caller 20 requests transfer of such impermissible data, the transfer is not allowed and an associated indicator is sent to the caller 20.

One approach for providing a privacy zone indicator to the caller uses session initiation protocol (SIP). SIP is commonly used for basic query responses for multimedia and other sessions. The following, in Table 1, are codes provided in RFC 3261 and 3265 for unsuccessful calls.

TABLE 1

| Response Code | Reference |
|---|---|
| Provisional 1xx | |
| 181 Call Is Being Forwarded | |
| 182 Queued | |
| 183 Session Progress | |
| Redirection 3xx | |
| 300 Multiple Choices | |
| 301 Moved Permanently | |
| 302 Moved Temporarily | |
| 305 Use Proxy | |
| 380 Alternate Service | |
| Request Failure 4xx | |
| 400 Bad Request | |
| 401 Unauthorized | |
| 402 Payment Required | |
| 403 Forbidden | |
| 404 Not Found | |
| 405 Method Not Allowed | |
| 406 Not Accepted | |
| 407 Proxy Authentication Required | |
| 408 Request Timeout | |
| 410 Gone | |
| 413 Request Entity Too Large | |
| 414 Request-URI Too Long | |
| 415 Unsupported Media Type | |
| 416 Unsupported Media Type | |
| 420 Bad Extension | |
| 421 Extension Required | |
| 423 Interval Too Brief | |
| 429 Provide Referrer Identity | [RFC-ietf-sip-referredby-05.txt] |
| 480 Temporarily Unavailable | |
| 481 Call/Transaction Does Not Exist | |
| 482 Loop Detected | |
| 483 Too Many Hops | |
| 484 Address Incomplete | |
| 485 Ambiguous | |
| 486 Busy Here | |
| 487 Request Terminated | |
| 488 Not Accepted Here | |
| 489 Bad Event | [RFC3265] |
| 491 Request Pending | |
| 493 Undecipherable | |
| 494 Security Agreement Required | [RFC3329] |

An additional code for use in a SIP message is preferably provided to indicate that the WTRU is in a privacy zone. Additionally, codes may indicate which session types are permitted in the privacy zone, such as voice, SMS, MMS, data, etc. The code can be generated at the WTRU or within the wireless/communication network.

Another approach for privacy zone signaling uses SMS. When the user is in a privacy zone, an SMS message is generated indicating that the individual is in a privacy zone and/or which services are prohibited/permitted. Either the WTRU or wireless/communication network generates the SMS message.

Additionally, application specific signaling can be used to indicate the user is in a privacy zone. Each application has its own set of codes based on the logic inside the WTRU and the state of the WTRU. As an alternate to application specific signaling, an operating system/middleware construct can be provided available to all or a subset of applications. An example of an application type code would be to insert a code into an email message, when the WTRU is in a privacy zone.

What is claimed is:

1. A method for use when a wireless transmit/receive unit (WTRU) is in a controlled area where certain services are not permitted, the method comprising:
receiving a signal associated with a service not permitted in the controlled area for the WTRU; and
sending an identifier indicating that the WTRU is in a controlled area.

2. The method of claim 1 wherein the WTRU receives the signal.

3. The method of claim 1 wherein the received signal is a session initiation request of the service.

4. The method of claim 1 wherein the received signal is data of the service.

5. The method of claim 1 wherein the sending an identifier includes an identifier of services that the WTRU is permitted to use in the controlled area.

6. The method of claim 1 wherein the sending of the identifier is by a code of a session initiation protocol message.

7. The method of claim 1 wherein the sending of the identifier is by an short message service message.

8. The method of claim 1 wherein the sending of the identifier is by application specific signaling.

9. The method of claim 1 wherein the sending of the identifier is performed by a network.

10. The method of claim 1 further comprising a network storing data of the service while the WTRU is in the controlled area and sending the stored service data to the WTRU when the WTRU is out of the controlled area.

11. The method of claim 1 further comprising rerouting the session data when the WTRU is in the controlled area.

12. The method of claim 11 wherein the rerouting is performed by a network.

13. The method of claim 12 wherein the WTRU sends an identifier to the network to have the network reroute the data.

14. The method of claim 12 wherein the rerouting is performed by the WTRU.

15. The method of claim 1 further comprising overriding restrictions of the controlled area by the WTRU or a caller.

16. A method for controlling data transfer of data associated with a controlled area, where a transfer of certain collected data is restricted, the method comprising:
collecting data associated with the controlled area;
identifying the collected data as being associated with the controlled area; and
restricting transfer of the identified collected data, where data that is not identified as being associated with the controlled area is not restricted.

17. The method of claim 16 wherein the identifier is a watermark of the collected data.

18. The method of claim 16 wherein the identifier is metadata of the collected data.

19. A wireless transmit/receive unit (WTRU) comprising:
a transceiver for receiving a signal associated with a service not permitted in a controlled area that the WTRU is located; and
a signal/messaging device for producing an identifier that the WTRU is in a controlled area, in response to the receiving the signal; and
the transceiver for transmitting the identifier.

20. The WTRU of claim 19 wherein the received signal is a session initiation request of the service.

21. The WTRU of claim 19 wherein the received signal is data of the service.

22. The WTRU of claim 19 wherein the signal/messaging device for producing an identifier of services that the WTRU is permitted to use in the controlled area.

23. The WTRU of claim 19 wherein the identifier is a code of a session initiation protocol message.

24. The WTRU of claim 19 wherein the identifier is included in a short message service message.

25. The WTRU of claim 19 wherein the identifier is produced by application specific signaling.

26. The WTRU of claim 19 wherein the transceiver sends a signal to the network so that the service data is rerouted to an alternate device.

27. The WTRU of claim 19 wherein the transceiver sends a signal to the network so that the network stores the service data while the WTRU is in the controlled area.

28. The WTRU of claim 19 wherein the service data is received by the transceiver and rerouted by the WTRU.

29. The WTRU of claim 19 wherein the transceiver and the signal/messaging device are on an integrated circuit.

30. A wireless transmit/receive unit (WTRU) comprising:
means for collecting data associated with a controlled area that the WTRU is located;
means for identifying the collected data as being associated with the controlled area; and
means for restricting transfer of the identified collected data, where data that is not identified as being associated with the controlled area is not restricted.

31. The WTRU of claim 30 wherein the identifier is a watermark of the collected data.

32. The WTRU of claim 30 wherein the identifier is metadata of the collected data.

33. A network controller comprising:
a processing device for receiving a signal associated with a service not permitted in a controlled area for a wireless transmit/receive unit and producing an identifier indicating that the WTRU is in a controlled area, the identifier routed to a device producing the received signal.

34. The network controller of claim 33 wherein the received signal is a session initiation request of the service.

35. The network controller of claim 33 wherein the received signal is data of the service.

36. The network controller of claim 33 wherein the processing device producing an identifier of services that the WTRU is permitted to use int eh controlled area to be routed to the device producing the received signal.

37. The network controller of claim 33 wherein the identifier is a code of a session initiation protocol message.

38. The network controller of claim 33 wherein the identifier is included in a short message service message.

39. The network controller of claim 33 further comprising a memory for storing service data while the WTRU is in the controlled area for later transfer to the WTRU.

40. The network controller of claim 33 wherein the processing device rerouting session data while the WTRU is in the controlled area.

41. The network controller of claim 40 wherein the processing device reroutes the session data in response to receipt of an appropriate signal from the WTRU.

42. The network controller of claim 33 wherein the processing device overriding restriction of a controlled area in response to a signal received from the WTRU or a caller.

43. The network controller of claim 33 further comprising a database indicating whether the WTRU is in a controlled area.

44. The network controller of claim 33 wherein the processing device is implemented on an integrated circuit.

45. A network controller comprising:
a memory for collecting data associated with a wireless transmit/receive unit and storing an identifier of the collected data as being associated with a controlled area; and
a processing device for restricting transfer of the identified collected data, where data that is not identified as being associated with the controlled area is not restricted.

46. The network controller of claim 45 wherein the identifier is a watermark of the collected data.

47. The network controller of claim 45 wherein the identifier is metadata of the collected data.
